(19) United States
(12) Patent Application Publication
(10) Pub. No.: US 2008/0231621 A1
(43) Pub. Date: Sep. 25, 2008

(54) LIQUID CRYSTAL DISPLAY APPARATUS, BACKLIGHT MODULE AND LIGHT SOURCE DRIVING DEVICE THEREOF

(76) Inventors: Yu-Ching CHANG, Taoyuan Hsien (TW); Jyun-Hong CHEN, Taoyuan Hsien (TW)

Correspondence Address: BIRCH STEWART KOLASCH & BIRCH, PO BOX 747, FALLS CHURCH, VA, 22040-0747, US

(21) Appl. No.: 12/027,891

(22) Filed: Feb. 7, 2008

(30) Foreign Application Priority Data
Mar. 21, 2007 (TW) 096109674

(51) Int. Cl. G06F 3/038; G09G 3/36

(52) U.S. Cl. 345/211; 345/102

(57) ABSTRACT

A light source driving device for driving a plurality of light-emitting units includes a power supply unit and a feedback control unit. The power supply unit is electrically connected to the light-emitting units and outputs a driving signal for driving the light-emitting units. The feedback control unit is electrically connected to the power supply unit and between any two light-emitting units, and retrieves a feedback signal from the light-emitting units to generate a pulse width modulation (PWM) signal for controlling the light-emitting units.

### CROSS REFERENCE TO RELATED APPLICATIONS

This Non-provisional application claims priority under 35 U.S.C. §119(a) on Patent Application No(s). 096109674 filed in Taiwan, Republic of China on Mar. 21, 2007, the entire contents of which are hereby incorporated by reference.

### BACKGROUND OF THE INVENTION

1. Field of Invention

The invention relates to a liquid crystal display (LCD) apparatus, a backlight module and a light source driving device thereof.

2. Related Art

A light emitting diode (LED) has been widely used in the daily life and electronic products because it has the advantages of low power-consumption, long lifetime and good color saturation. In addition, because the LED has rich color temperatures in the three-primary colors and high light-emitting efficiency, the LED has been gradually applied to a backlight module of a LCD apparatus to serve as an illumination light source.

FIG. 1 is a schematic illustration showing a circuit of a conventional light source driving device 1. Referring to FIG. 1, the conventional light source driving device 1 includes a current supply 11, a plurality of LEDs as a LED string 12, a comparator OP₁, a controller 13 and a switch 14. The current supply 11 outputs a current driving signal S₁₁ to the LED string 12. The comparator OP₁ compares a current reference signal S131 with a current signal S₁₂, which is obtained from the LED string 12, and thus outputs a comparison signal S₁₃₂ to the controller 13. The controller 13 receives the comparison signal S₁₃₂ and converts the comparison signal S₁₃₂ into a control signal S₁₃ (e.g., a PWM signal) and then outputs the control signal S₁₃. The switch 14 turns on or off according to the control signal S₁₃ so as to control the luminance of the LED string 12.

The above-mentioned method is to compare the current signal S₁₂, which is obtained from the LED string 12, with the current reference signal S₁₃₁ to control the luminance of the LED string 12. However, using the current serving as the reference of controlling the LED string 12 to emit light is easily influenced by the unstable current driving signal S₁₁ so that the current level will shift and the luminance of the LED string 12 cannot be easily controlled. In addition, when the number of the LED connected in parallel in the LED strings 12 is increased, the power consumed by the resistor R, which is connected to the LED string 12 in series, in the light source driving device 1 is also increased. Thus, the unnecessary power consumption will occur.

Therefore, it is an important subject to provide a LCD apparatus, a backlight module and a light source driving device capable of precisely controlling the luminance of a LED string and reducing the power consumption.

### SUMMARY OF THE INVENTION

In view of the foregoing, the invention is to provide a LCD apparatus, a backlight module and a light source driving device capable of precisely controlling the luminance of a LED string and reducing the power consumption.

To achieve the above the invention discloses a light source driving device for driving a plurality of light-emitting units. The light source driving device includes a power supply unit and a feedback control unit. The power supply unit is electrically connected to the light-emitting units and outputs a driving signal for driving the light-emitting units. The feedback control unit is electrically connected to the power supply unit and between any two of the light-emitting units. The feedback control unit retrieves a feedback signal to generate a pulse width modulation (PWM) signal for controlling the light-emitting units.

To achieve the above, the invention also discloses a backlight module including a backpanel and a light source driving device. The backpanel has a chamber, and the light source driving device is disposed in the chamber for driving a plurality of light-emitting units. The light source driving device includes a power supply unit and a feedback control unit. The power supply unit is electrically connected to the light-emitting units and outputs a driving signal to drive the light-emitting units. The feedback control unit is electrically connected to the power supply unit and between any two of the light-emitting units. The feedback control unit retrieves a feedback signal to generate a pulse width modulation (PWM) signal for controlling the light-emitting units.

To achieve the above, the invention further discloses a liquid crystal display (LCD) apparatus including a liquid crystal display (LCD) panel and a backlight module disposed at one side of the LCD panel. The backlight module has a light source driving device for driving a plurality of light-emitting units. The light source driving device has a power supply unit and a feedback control unit. The power supply unit is electrically connected to the light-emitting units and outputs a driving signal to drive the light-emitting units. The feedback control unit is electrically connected to the power supply unit and between any two of the light-emitting units. The feedback control unit retrieves a feedback signal to generate a pulse width modulation (PWM) signal for controlling the light-emitting units.

As mentioned above, in the LCD apparatus, the backlight module and the light source driving device of the invention, the feedback signal is obtained by the feedback control unit, which is electrically connected to and between any two light-emitting units. Compared with the related art, the invention can obtain the desired feedback signal through the simple design of the feedback control unit so that the luminance of the light-emitting unit can be precisely adjusted and the unnecessary power consumption generated by the current feedback control can be reduced.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and accompanying drawings which are given by way of illustration only, and thus are not limitative of the present invention, and wherein:

FIG. 1 is a schematic illustration showing a circuit of a conventional light source driving device;

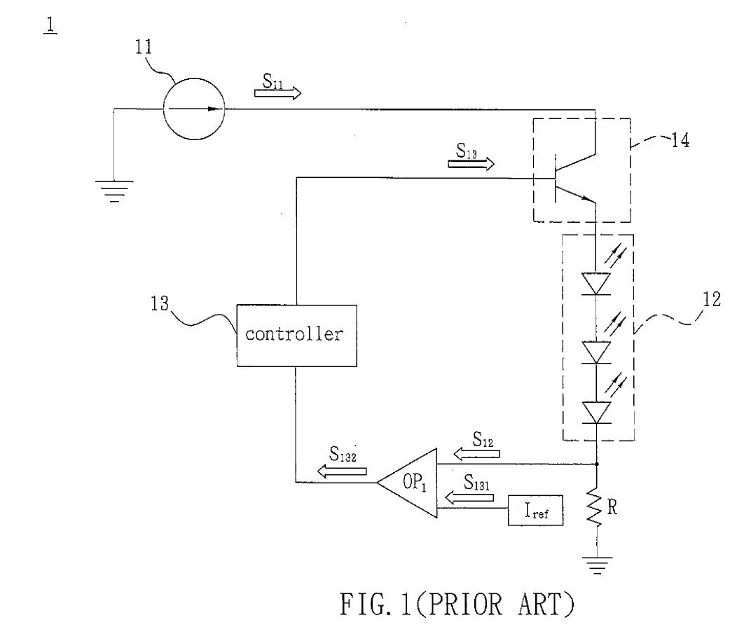

FIG. 2 is a schematic block diagram showing a light source driving device according to an embodiment of the invention;

FIG. 3 is a schematic illustration showing a circuit of the light source driving device according to the embodiment of the invention; and

FIG. 4 is a cross-sectional illustration showing a structure of a LCD apparatus according to the embodiment of the invention.

### DETAILED DESCRIPTION OF THE INVENTION

The present invention will be apparent from the following detailed description, which proceeds with reference to the accompanying drawings, wherein the same references relate to the same elements.

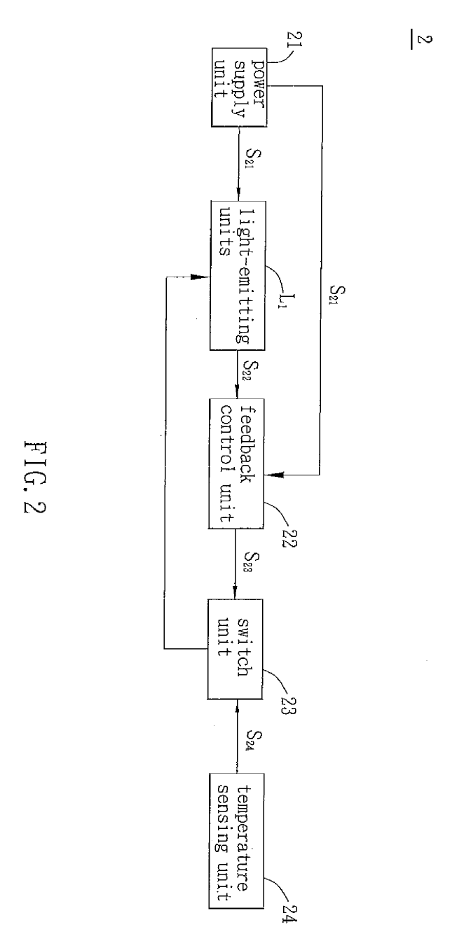

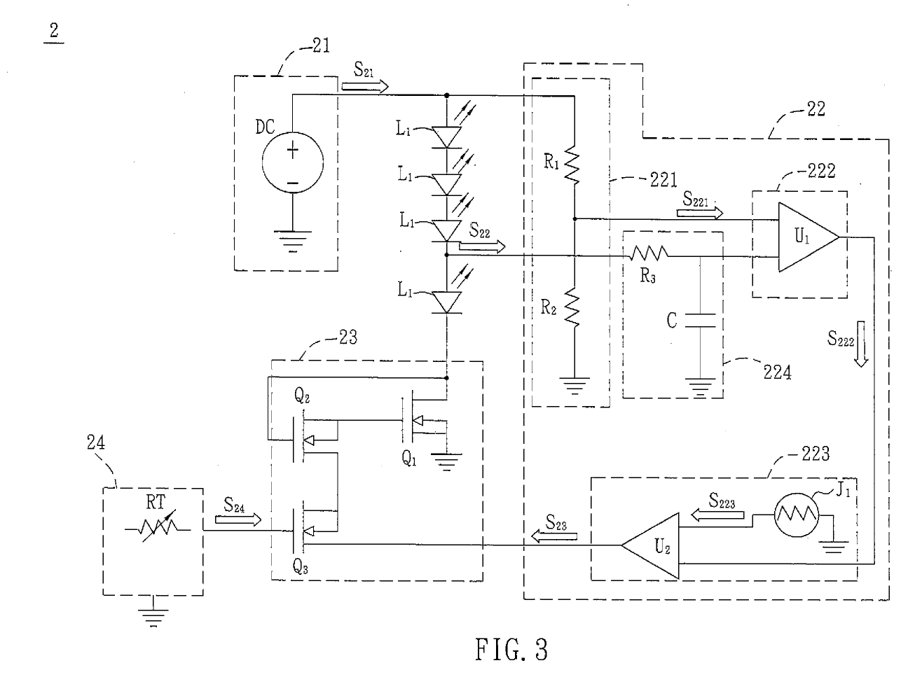

Please refer to FIGS. 2 and 3. FIG. 2 is a schematic block diagram showing a light source driving device according to an embodiment of the invention. FIG. 3 is a schematic illustration showing a circuit of the light source driving device according to the embodiment of the invention.

As shown in FIGS. 2 and 3, a light source driving device 2 drives a plurality of light-emitting units L₁, and includes a power supply unit 21, a feedback control unit 22, a switch unit 23 and a temperature sensing unit 24. In this embodiment, the light-emitting units L₁ may be implemented by LEDs.

The power supply unit 21 outputs a driving signal S₂₁ to the light-emitting units L₁ and the feedback control unit 22. The feedback control unit 22 is electrically connected to and between any two light-emitting units L₁ to retrieve a feedback signal S₂₂ and thus to output a PWM signal S₂₃. The temperature sensing unit 24 senses an environment temperature and thus generates a sensing signal S₂₄. The switch unit 23 controls the current flowing through the light-emitting units L₁ according to the PWM signal S₂₃ and the sensing signal S₂₄ to adjust the luminance of the light-emitting units L₁. In this embodiment each of the driving signal S₂₁, the feedback signal S₂₂, the PWM signal S₂₃ and the sensing signal S₂₄ is a voltage signal.

Referring to FIG. 3, the feedback control unit 22 has a voltage-dividing circuit 221, a comparison circuit 222 and a PWM circuit 223.

The voltage-dividing circuit 221 has a first resistor R₁ and a second resistor R₂, which are connected to and between the power supply unit 21 and a ground in series. The voltage-dividing circuit 221 divides the voltage of the driving signal S₂₁ outputted from the power supply unit 21 to generate a reference voltage signal S₂₂₁.

The comparison circuit 222 has a first comparator U₁, which compares the feedback signal S₂₂ with the reference voltage signal S₂₂₁ to output a comparison signal S₂₂₂. In this embodiment, the first comparator U₁ is an operational amplifier or any element or circuit having the comparing function. Each of the reference voltage signal S₂₂₁ and the comparison signal S₂₂₂ is a voltage signal.

The PWM circuit 223 has an oscillator J₁ and a second comparator U₂. The oscillator J₁ outputs an oscillation signal S₂₂₃ to the second comparator U₂, and the second comparator U₂ compares the oscillation signal S₂₂₃ with the comparison signal S₂₂₂ to output the PWM signal S₂₃ accordingly. The oscillation signal S₂₂₃ can have a triangle wave or a sawtooth wave. In addition, the second comparator U₂ is an operational amplifier or any element or circuit having the comparing function.

It is to be noted that the technology of using the electrical element to achieve the function of the PWM circuit 223 pertains to the well-developed technology. Herein, the PWM circuit 223 is composed of, for example but not limited to, the comparator U₂ and the oscillator J₁. In practice, a control chip can be used to achieve the function of the PWM circuit 223.

The switch unit 23 includes a first switch element Q₁, a second switch element Q₂ and a third switch element Q₃. The first switch element Q₁ is electrically connected to the light-emitting unit L₁ and the second switch element Q₂. The second switch element Q₂ is electrically connected to the first switch element Q₁ and the third switch element Q₃. The third switch element Q₃ is electrically connected to the second switch element Q₂, the feedback control unit 22 and the temperature sensing unit 24. In this embodiment, each of the switch elements Q₁ to Q₃ can be a transistor, a bipolar function transistor, a metal oxide semiconductor field effect transistor (MOSFET) or any element or circuit having the switch function.

As shown in FIG. 3, the power supply unit 21 outputs the driving signal S₂₁, and the voltage-dividing circuit 221 of the feedback control unit 22 receives the driving signal S₂₁ and outputs the reference voltage signal S₂₂₁. The first comparator U₁ of the comparison circuit 222 compares the reference voltage signal S₂₂₁ with the feedback signal S₂₂, which is obtained from any two light-emitting units L₁, and thus outputs the comparison signal S₂₂₂ to the second comparator U₂ of the PWM circuit 223. The second comparator U₂ compares the oscillation signal S₂₂₃, which is outputted from the oscillator J₁, with the comparison signal S₂₂₂, which is outputted from the first comparator U₁, to output the PWM signal S₂₃. The PWM signal S₂₃ is transmitted to the first switch element Q₁ through the third switch element Q₃ and the second switch element Q₂, and thus controls the first switch element Q₁ to turn on or off. The operation of tuning on or off the first switch element Q₁ can adjust the current flowing through the light-emitting units L₁ and thus to control the luminance of the light-emitting units L₁.

The second switch element Q₂ is connected to the third switch element Q₃ in series and has the function of an AND circuit to detect whether the operation of the light-emitting units L₁ is normal. The PWM signal S₂₃ cannot be transmitted to the first switch element Q₁ until the switch elements Q₂ and Q₃ simultaneously turn on. If one of the switch elements Q₂ and Q₃ turns off, the PWM signal S₂₃ cannot be transmitted to the first switch element Q₁. In addition, when the light-emitting units L₁ have the abnormal operation due to the factor such as the open-circuit condition or the too-high temperature, the second switch element Q₂ also cuts off so that the feedback control unit 22 is disconnected from the switch unit 23 and the PWM signal S₂₃ cannot be transmitted. Thus, the function of circuit protection can be achieved.

In this embodiment, the feedback control unit 22 can further include a filter circuit 224 in order to prevent the feedback signal S₂₂ from carrying the noise to cause the feedback control unit 22 to have the malfunction. The filter circuit 224 receives and filters the feedback signal S₂₂ between any two light-emitting units L₁. In this embodiment, the filter circuit 224 is a low-pass filter circuit composed of a third resistor R₃ and a capacitor C. To be noted, the low-pass filter circuit has many embodiments, and this RC low-pass filter circuit is only illustrated for the illustrative purpose without any limitative sense.

The temperature sensing unit 24 can have a thermister RT, as shown in the drawing, a thermocouple or any element capable of generating the sensing signal S₂₄ according to the variation of the environment temperature. The thermister RT can also be a positive temperature coefficient thermister or a negative temperature coefficient thermister

In order to protect the light source driving device 2 in this embodiment, when the thermister RT of the temperature sensing unit 24 senses the external environment temperature being too high, the temperature sensing unit 24 is caused to output the sensing signal S₂₄ to the third switch element Q₃, and the third switch element Q₃ is caused to cut off so that the feedback control unit 22 is disconnected from the switch unit 23. Thus, the circuit of the light source driving device 2 is automatically cut off so that the functions of temperature sensing and circuit protection can be obtained.

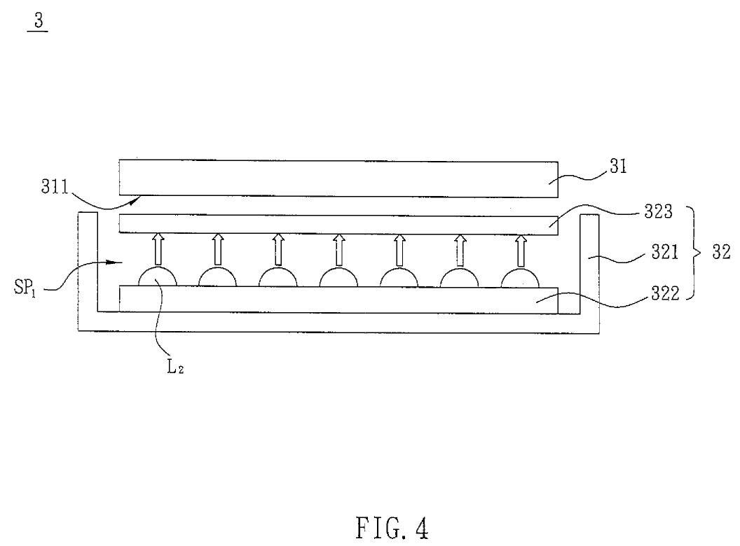

The backlight module and the LCD apparatus according to the embodiment of the invention will be described with reference to FIG. 4.

FIG. 4 is a cross-sectional illustration showing a structure of a LCD apparatus 3 according to the invention. Referring to FIG. 4, the LCD apparatus 3 includes a liquid crystal display panel 31 and a backlight module 32 disposed opposite to the liquid crystal display panel 31. In this embodiment, the backlight module 32 is a direct type backlight module, for example.

The backlight module 32 has a backpanel 321, a light source driving device 322 and a diffuser 323. The backpanel 321 has a chamber SP₁. The light source driving device 322 is disposed in the chamber SP₁ and drives a plurality of light-emitting units L₂. The light-emitting units L₂ respectively emit light rays, which pass through the diffuser 323 and are then diffused. Then, the light rays enter a light input surface 3 11 of the liquid crystal display panel 31 so that the light required by the liquid crystal display panel 31 is provided.

In this embodiment, the light source driving device 322 of the backlight module 32 can be the light source driving device 2 mentioned in the above-mentioned embodiment. The light-emitting unit L₂ and the light-emitting unit L₁ can have the same function, structure and arrangement, so detailed descriptions thereof will be omitted.

It is to be noted that the backlight module 32 is not particularly restricted to the direct type backlight module in this embodiment, and can also be an edge lighting backlight module. In addition, the structural arrangement of the light source driving device 322 is also made for the illustrative purpose, and is not particularly restricted to that of FIG. 4. That is, the structural arrangement of the light source driving device 322 can be used as long as the electrical connection relationship therebetween can be kept.

In summary, the feedback signal is obtained by the feedback control unit, which is electrically connected to and between any two light-emitting units. Compared with the related art, the invention can obtain the desired feedback signal through the simple design of the feedback control unit so that the luminance of the light-emitting unit can be precisely adjusted and the necessary power consumption generated by the current feedback control can be reduced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light source driving device for driving a plurality of light-emitting units, comprising:
a power supply unit electrically connected to the light-emitting units and outputting a driving signal for driving the light-emitting units; and
a feedback control unit electrically connected to the power supply unit and between any two of the light-emitting units, and retrieving a feedback signal to generate a pulse width modulation (PWM) signal for controlling the light-emitting units.

2. The light source driving device according to claim 1, wherein the feedback control unit comprises a voltage-dividing circuit electrically connected to the power supply unit to generate a reference voltage signal.

3. The light source driving device according to claim 2, wherein the voltage-dividing circuit comprises a first resistor and a second resistor connected to the first resistor in series.

4. The light source driving device according to claim 2, wherein the feedback control unit comprises a comparison circuit electrically connected to the voltage-dividing circuit and the light-emitting units, and the comparison circuit compares the reference voltage signal with the feedback signal to generate a comparison signal or a voltage signal.

5. The light source driving device according to claim 4, wherein the comparison circuit comprises an operational amplifier.

6. The light source driving device according to claim 1, wherein the feedback control unit comprises a filter circuit electrically connected to the light-emitting units and filtering the feedback signal.

7. The light source driving device according to claim 6, wherein the filter circuit has a third resistor and a capacitor.

8. The light source driving device according to claim 4, wherein the feedback control unit comprises a pulse width modulation (PWM) circuit or a control chip electrically connected to the comparison circuit and the light-emitting units for converting the comparison signal into the PWM signal.

9. The light source driving device according to claim 8, wherein the PWM circuit comprises an operational amplifier and an oscillator, the oscillator generates an oscillation signal, and the operational amplifier compares the oscillation signal with the comparison signal to generate the PWM signal.

10. The light source driving device according to claim 1, further comprising a switch unit electrically connected to the light-emitting units and the feedback control unit.

11. The light source driving device according to claim 10, further comprising a temperature sensing unit electrically connected to the switch unit, sensing an environment temperature to generate a sensing signal or a voltage signal, and controlling the light-emitting units through the switch unit.

12. The light source driving device according to claim 11, wherein the temperature sensing unit includes a thermister or a thermocouple.

13. The light source driving device according to claim 11, wherein the switch unit has a first switch element, a second switch element and a third switch element, and the first switch element is electrically connected to the light-emitting units and the second switch element, the second switch element is electrically connected to the first switch element and the third switch element, and the third switch element is electrically connected to the second switch element, the feedback control unit and the temperature sensing unit.

14. The light source driving device according to claim 13, wherein the second switch element and the third switch element are connected in series to form an AND gate circuit.

15. The light source driving device according to claim 13, wherein the first switch element the second switch element and the third switch element are transistors, bipolar junction transistors (BJT), or metal oxide semiconductor field effect transistors (MOSFET).

16. The light source driving device according to claim 1, wherein the light-emitting units are light-emitting diodes.

17. A backlight module comprising:
a backpanel having a chamber; and
a light source driving device disposed in the chamber for driving a plurality of light-emitting units, wherein the light source driving device comprises a power supply unit and a feedback control unit, the power supply unit is electrically connected to the light-emitting units and outputs a driving signal to drive the light-emitting units, and the feedback control unit is electrically connected to the power supply unit and between any two of the light-emitting units and retrieves a feedback signal to generate a pulse width modulation (PWM) signal for controlling the light-emitting units.

18. A liquid crystal display apparatus comprising:
a liquid crystal display panel; and
a backlight module disposed at one side of the liquid crystal display panel, wherein the backlight module has a light source driving device for driving a plurality of light-emitting units, the light source driving device has a power supply unit and a feedback control unit, the power supply unit is electrically connected to the light-emitting units and outputs a driving signal to drive the light-emitting units, and the feedback control unit is electrically connected to the power supply unit and between any two of the light-emitting units and retrieves a feedback signal to generate a pulse width modulation (PWM) signal for controlling the light-emitting units.

19. The LCD apparatus according to claim 18, wherein the backlight module comprises a backpanel having a chamber for accommodating the light source driving device.

20. The LCD apparatus according to claim 18, wherein the backlight module comprises a diffuser, and light rays respectively output from the light-emitting units are diffused by the diffuser and then enter a light input surface of the liquid crystal display panel.
